(19) United States
(12) Patent Application Publication
(10) Pub. No.: US 2009/0237569 A1
(43) Pub. Date: Sep. 24, 2009

(54) TRANSCODER

(75) Inventors: Makoto Saito, Osaka (JP); Hiromu Hasegawa, Osaka (JP); Miyuki Yanagida, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: MegaChips Corporation, Osaka-shi (JP); NTT ELECTRONICS CORPORATION, Shibuya-ku (JP)

(21) Appl. No.: 12/400,132

(22) Filed: Mar. 9, 2009

(30) Foreign Application Priority Data
Mar. 24, 2008 (JP) 2008-075050

(51) Int. Cl. H04N 5/14

(52) U.S. Cl. 348/700; 348/E05.062

(57) ABSTRACT

A scene change detection part detects a scene change based on a characteristic amount of an input image. A target code amount setting part executes correction by a correction code amount on a target code amount previously set for suppressing variation of an output code amount around the time of scene change. A quantization step value setting part sets a quantization step value based on the target code amount. That is to say, a transcoder 1 does not detect a scene change by previously reading an input image or by detecting variation of the output code amount.

### BACKGROUND OF THE INVENTION

1. Field of the Invention

The present invention relates to a transcoder for decoding an input image into a decoded image and encoding the decoded image into an output image.

2. Description of the Background Art

Image compression techniques are widely used for reducing transmission load and storing load of image data. There are MPEG 2 and the like as conventional coding systems, and H.264 and the like as new coding systems. A transcoder executes system conversion between different coding systems for reducing transmission load and storing load of image data.

As a first stage, a transcoder inputs a compressed image by a first coding system to generate an extension image by the first coding system. As a second stage, the transcoder compresses the extension image by a second coding system to output a compressed image by the second coding system.

A transcoder can detect a scene change. For example, the transcoder can detect a fact that a moving image changes to a fine image from a flat image. When the transcoder detects a scene change, the transcoder can prevent deterioration of image quality at the time of the scene change while suppressing variation of an output code amount. For example, the transcoder can prevent deterioration of image quality at the time of a scene change while suppressing an increase in the output code amount along with the change of the moving image to a fine image from a flat image.

A coding apparatus compresses an input image to output a compressed image. A general coding apparatus can detect a scene change by previously reading an input image. A coding apparatus disclosed in Japanese Patent Application Laid Open Gazette No. 2001-251630 can detect a scene change by detecting variation of an output code amount.

A general coding apparatus detects a scene change by previously reading an input image. The coding apparatus cannot yet execute control for suppressing variation of an output code amount on an input image which is not previously read. The coding apparatus can manage to control for suppressing variation of the output code amount on a previously-read input image. The coding apparatus causes increase in circuit scale and delay in control process because the apparatus need to include a previously-read portion and a coding portion.

The coding apparatus disclosed in Japanese Patent Application Laid Open Gazette No. 2001-251630 can detect a scene change by detecting variation of an output code amount. The coding apparatus can no longer control for suppressing variation of the output code amount on a compressed image in which variation of the output code amount is detected. The coding apparatus can manage to control for suppressing variation of the output code amount on an input image subsequent to the compressed image in which variation of the output code amount is detected. Therefore, the coding apparatus cannot effectively prevent deterioration of image quality at the time of a scene change while effectively suppressing variation of the output code amount when the coding apparatus detects the scene change.

### SUMMARY OF THE INVENTION

The present invention is directed to a transcoder for decoding an input image into a decoded image and encoding the decoded image into an output image. The transcoder according to the invention comprises a characteristic amount detection part which detects a characteristic amount of the input image, a scene change detection part which determines that when a differential value between a characteristic amount of a previous input image and a characteristic amount of a subsequent input image is larger than a predetermined characteristic amount differential value, a scene change occurs between the previous input image and the subsequent input image, a target code amount setting part which sets a target code amount of the output image based on the characteristic amount of the input image, and a target code amount correction part which corrects a target code amount of a subsequent output image by a correction code amount such that a variation from an output code amount of a previous output image corresponding to the previous input image to an output code amount of the subsequent output image corresponding to the subsequent input image when the scene change occurs.

According to the invention, increase in circuit scale and delay in control process can be prevented.

According to another aspect of the invention, the target code amount correction part includes a target code amount correction end part which ends correction of the target code amount of the output image after a first predetermined period of time since correction of the target code amount of the output image starts.

Deterioration of image quality at the time of the scene change of the output image can be effectively prevented while effectively suppressing variation of the output code amount, when the scene change is detected.

Therefore, an object of the invention is to provide a transcoder which does not cause increase in circuit scale and delay in control process. Further, another object of the invention is to provide a transcoder which effectively prevents deterioration of image quality at the time of the scene change of the output image while effectively suppressing variation of the output code amount when the scene change is detected.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing components of a transcoder.

FIG. 2 is a flowchart showing a process flow of detecting a scene change.

FIG. 3 is a flowchart showing a process flow of setting a target code amount.

FIGS. 4A to 4C are time charts showing a process flow by a transcoder.

FIGS. 5A to 5C are time charts showing a process flow by a transcoder.

FIG. 6 is a drawing showing a picture used in detection of a scene change.

FIGS. 7A to 7F are drawings showing pictures used in restart of detection of a scene change.

### DESCRIPTION OF THE PREFERRED EMBODIMENTS

{Components of a Transcoder}

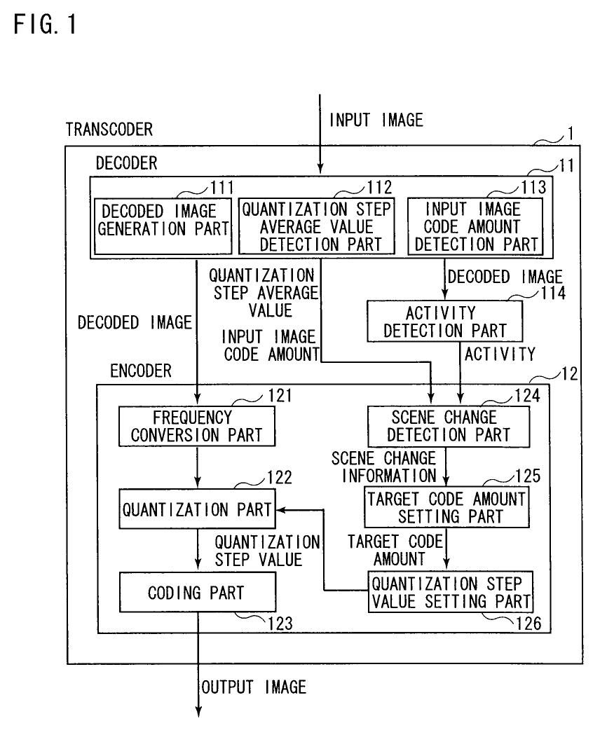

Hereinafter, embodiments of the invention will be described with reference to drawings. FIG. 1 is a block diagram showing components of a transcoder 1. The transcoder 1 comprises a decoder 11, an encoder 12, an activity detection part 114 and the like.

The decoder 11 inputs an input image from an outside of the transcoder 1. The input image is decoded into a decoded image by a coding system to which the decoder 11 handles. The decoder 11 outputs the decoded image to the encoder 12.

The encoder 12 inputs the decoded image from the decoder 11. The decoded image is encoded into an output image by a coding system to which the encoder 12 handles. The encoder 12 outputs the output image to the outside of the transcoder 1.

The decoder 11 comprises a decoded image generation part 111, a quantization step average value detection part 112, an input image code amount detection part 113 and the like. The encoder 12 comprises a frequency conversion part 121, a quantization part 122, a coding part 123, a scene change detection part 124, a target code amount setting part 125, a quantization step value setting part 126 and the like.

The decoded image generation part 111 generates a decoded image by executing decoding, inverse-quantization and inverse-frequency-conversion on the input image.

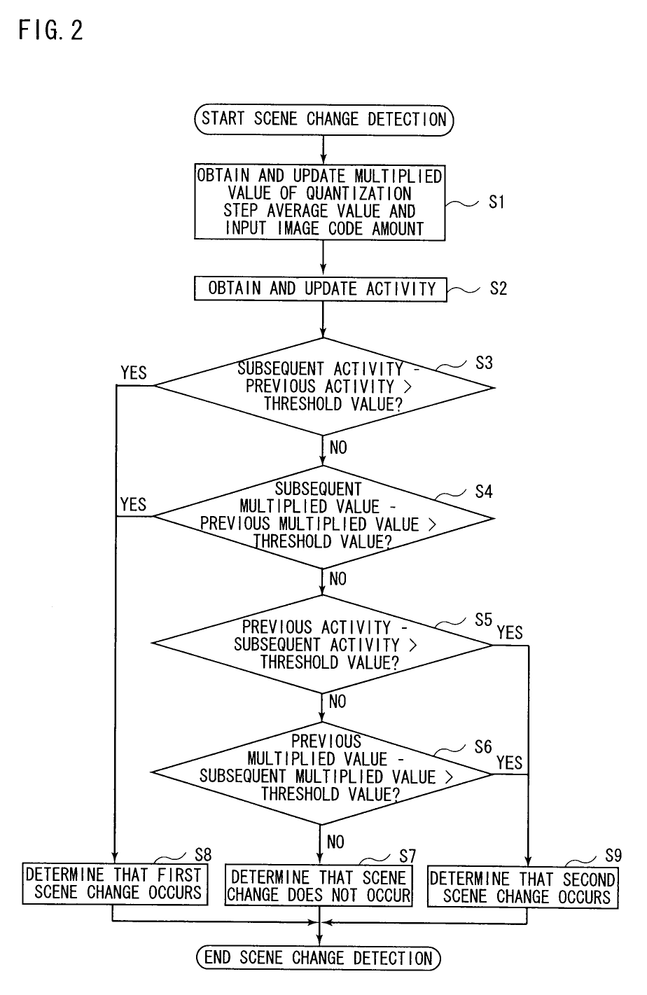

The quantization step average value detection part 112 detects a quantization step average value of the input image. The quantization step average value will be described later with reference to FIG. 2.

The input image code amount detection part 113 detects an input image code amount of the input image. The input image code amount will be described later with reference to FIG. 2.

The activity detection part 114 detects an activity of the decoded image. The activity will be described later with reference to FIG. 2.

The frequency conversion part 121 executes frequency conversion on the decoded image. The quantization part 122 executes quantization on the decoded image on which frequency conversion is executed, based on the quantization step value set by a quantization step value setting part 126 which will be described later. The coding part 123 executes encoding on the decoded image on which frequency conversion and quantization are executed.

The scene change detection part 124 detects a scene change based on the activity, the quantization step average value, and the input image code amount. For example, the scene change detection part 124 detects a fact that a moving image changes to a fine image from a flat image.

The target code amount setting part 125 sets a target code amount based on scene change information. For example, the target code amount setting part 125 executes reduction correction by a correction code amount on the target code amount previously set for suppressing an increase in the output code amount when the moving image changes to the fine image from the flat image.

The quantization step value setting part 126 sets a quantization step value based on the target code amount. For example, the quantization step value setting part 126 sets the quantization step value such that the quantization step value is not drastically small because the increase in the output code amount is suppressed when the moving image changes to the fine image from the flat image.

{Process Flow of Detection of Scene Change}

FIG. 2 is a flowchart showing a process flow of detecting a scene change. The scene change detection part 124 compares a fineness degree of a previous input image with that of a subsequent input image which is input subsequently to the previous input image. The scene change detection part 124 determines that the scene change occurs between the previous input image and the subsequent input image when the fineness degree of the subsequent input image largely changes from that of the previous input image. The scene change detection part 124 determines that a scene change does not occur between the previous input image and the subsequent input image when the fineness degree of the subsequent input image does not largely change from that of the previous input image.

The scene change detection part 124 repeats comparison of the fineness degree of the subsequent input image with that of the previous input image as successive first process and second process which will be described below.

In the first process, the scene change detection part 124 stores information showing a fineness degree of a first input image in advance. The scene change detection part 124 newly obtains information showing a fineness degree of a second input image which is a subsequent input image of the first input image. The scene change detection part 124 compares the fineness degree of the second input image with that of the first input image.

In the second process, the scene change detection part 124 stores information showing the fineness degree of the second input image in advance. The scene change detection part 124 newly obtains information showing a fineness degree of a third input image which is a subsequent input image of the second input image. The scene change detection part 124 compares the fineness degree of the third input image with that of the second input image.

The previous input image and the subsequent input image in the first process are the first input image and the second input image, respectively. The previous input image and the subsequent input image in the second process are the second input image and the third input image, respectively. When the successive first process and second process are compared with each other, it is found that the previous input image and the subsequent input image are momentarily updated.

The scene change detection part 124 obtains a quantization step average value from the quantization step average value detection part 112. The scene change detection part 124 obtains an input image code amount from the input image code amount detection part 113. The scene change detection part 124 calculates a multiplied value by multiplying the quantization step average value by the input image code amount (step S1). The quantization step average value is obtained by averaging the quantization step value in each block of the input image for the total block number of the input image. The multiplied value is an amount representing the fineness degree of the input image.

The scene change detection part 124 obtains an activity from the activity detection part 114 (step S2). The activity is a value obtained by dividing a value obtained by summing difference absolute values between pixel values of adjacent pixels of the decoded image for all adjacent pixels by the total block number of the decoded image. The activity is an amount representing the fineness degree of the input image.

The scene change detection part 124 subtracts the activity of the previous input image from the activity of the subsequent input image (step S3). When the subtracted value at step S3 is larger than a positive predetermined threshold value (YES at step S3), the scene change detection part 124 determines that a first scene change occurs between the previous input image and the subsequent input image (step S8). When the subtracted value at step S3 is equal to or less than the positive predetermined threshold value (NO at step S3), the scene change detection part 124 proceeds to step S4.

The scene change detection part 124 subtracts the multiplied value of the previous input image from the multiplied value of the subsequent input image (step S4). When the subtracted value at step S4 is larger than a positive predetermined threshold value (YES at step S4), the scene change detection part 124 determines that the first scene change occurs between the previous input image and the subsequent input image (step S8). When the subtracted value at step S4 is equal to or less than the positive predetermined threshold value (NO at step S4), the scene change detection part 124 proceeds to step S5.

In the first scene change, the fineness degree of the subsequent input image is significantly higher than that of the previous input image. The scene change detection part 124 can detect the first scene change based on both the activity and the multiplied value.

The scene change detection part 124 subtracts the activity of the subsequent input image from the activity of the previous input image (step S5). When the subtracted value at step S5 is larger than a positive predetermined threshold value (YES at step S5), the scene change detection part 124 determines that a second scene change occurs between the previous input image and the subsequent input image (step S9). When the subtracted value at step S5 is equal to or less than the positive predetermined threshold value (NO at step S5), the scene change detection part 124 proceeds to step S6.

The scene change detection part 124 subtracts the multiplied value of the subsequent input image from the multiplied value of the previous input image (step S6). When the subtracted value at step S6 is larger than a positive predetermined threshold value (YES at step S6), the scene change detection part 124 determines that the second scene change occurs between the previous input image and the subsequent input image (step S9). When the subtracted value at step S6 is equal to or less than the positive predetermined threshold value (NO at step S6), the scene change detection part 124 determines that neither of the first scene change nor the second scene change occurs between the previous input image and the subsequent input image (step S7).

In the second scene change, the fineness degree of the subsequent input image is significantly lower than that of the previous input image. The scene change detection part 124 can detect the second scene change based on both the activity and the multiplied value.

At the start of transcoding, the scene change detection part 124 does not store information of the activity to be compared with the activity of the first input image. At the start of transcoding, the scene change detection part 124 does not store information of the multiplied value to be compared with the multiplied value of the first input image.

The scene change detection part 124 may start, upon input of an Nth input image, comparing the activity and the multiplied value of the subsequent input image with those of the previous input image. Here, N denotes a natural number of 2 or more.

The scene change detection part 124 may compare an intensity of movement of the subsequent input image with an intensity of movement of the previous input image. The scene change detection part 124 may determine that the scene change occurs between the previous input image and the subsequent input image when the intensity of movement of the subsequent input image largely changes from the intensity of movement of the previous input image. The scene change detection part 124 may determine that the scene change does not occur between the previous input image and the subsequent input image when the intensity of movement of the subsequent input image does not largely change from the intensity of movement of the previous input image.

The intensity of movement of the input image may be a value obtained by dividing a value obtained by summing code amounts or lengths of moving vectors in each block of the input image for all blocks of the input image by the total block number of the input image.

{Process Flow of Target Code Amount Setting}

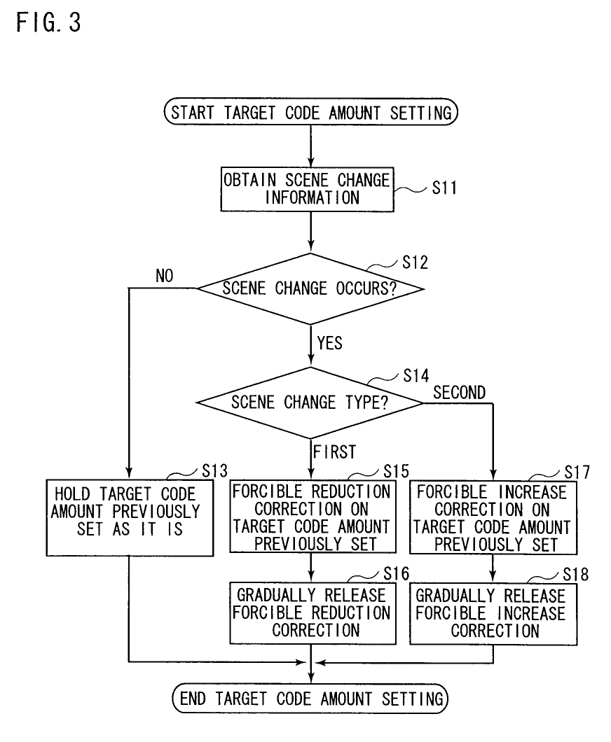

FIG. 3 is a flowchart showing a process flow of setting a target code amount. The target code amount setting part 125 obtains scene change information from the scene change detection part 124 (step S11). The target code amount setting part 125 executes correction by the correction code amount on the target code amount previously set when the fineness degree of the subsequent input image is largely different in comparison with that of the previous input image. The target code amount setting part 125 holds the target code amount previously set as it is when the fineness degree of the subsequent input image is not largely different in comparison with that of the previous input image.

A case where the first scene change or the second scene change does not occur is discussed (NO at step S12). That is to say, a case where the fineness degree of the subsequent input image is not significantly higher or lower than that of the previous input image is discussed. The target code amount setting part 125 holds the target code amount previously set as it is (step S13).

A case where the first scene change occurs is discussed (YES at step S12 and “FIRST” at step S14). That is to say, a case where the fineness degree of the subsequent input image is significantly higher than that of the previous input image is discussed. The target code amount setting part 125 forcibly executes reduction correction by the correction code amount on the target code amount previously set (step S15). That is to say, the target code amount setting part 125 tries to suppress the increase in the output code amount. Then, the target code amount setting part 125 gradually releases the forcible reduction correction with an elapse of the time after the first scene change (step S16).

A case where the second scene change occurs is discussed (YES at step S12 and “SECOND” at step S14). That is to say, a case where the fineness degree of the subsequent input image is significantly lower than that of the previous input image is discussed. The target code amount setting part 125 forcibly executes increase correction by the correction code amount on the target code amount previously set (step S17). That is to say, the target code amount setting part 125 tries to suppress a decrease in the output code amount. Then, the target code amount setting part 125 gradually releases forcible increase correction with an elapse of the time after the second scene change (step S18).

The correction code amount is set based on a difference in the fineness degree of the input image between before and after the scene change, or a difference in the intensity of movement of the input image between before and after the scene change.

An absolute value of the correction code amount may be set to be larger when the difference in the fineness degree of the input image between before and after the scene change is large, or may be set to be larger when the intensity of movement of the input image between before and after the scene change is large.

The absolute value of the correction code amount may be set to be smaller when the difference in the fineness degree of the input image between before and after the scene change is small, or may be set to be smaller when the intensity of movement of the input image between before and after the scene change is small.

{First Specific Example of Process Flow by the Transcoder 1}

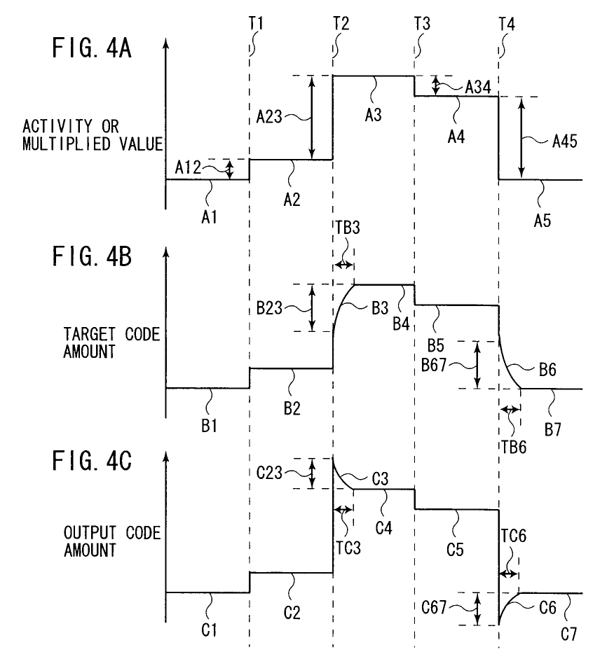

FIGS. 4A to 4C are time charts showing a first specific example of process flow by the transcoder 1. Also, FIG. 4A is a time chart showing a time change of the activity or the multiplied value. FIG. 4B is a time chart showing a time change of the target code amount. FIG. 4C is a time chart showing a time change of the output code amount. Four dashed lines passing through FIGS. 4A to 4C in the vertical direction represent times T1, T2, T3, and T4 in the order from the left side to the right side.

The activity or the multiplied value varies momentarily. However, in FIG. 4A, the activity or the multiplied value varies only at the times T1, T2, T3, and T4 for convenience of explanation.

In the first specific example, the target code amount previously set at step S13, S15, and S17 is the target code amount which is set for each predetermined unit based on the fineness degree of the input image included in the predetermined unit such as a GOP unit and is not corrected.

By the time T1, the activity or the multiplied value takes a value represented by a segment A1. The target code amount is set to be a value represented by a segment B1 in accordance with the value represented by the segment A1. The output code amount takes a value represented by a segment C1 in accordance with the value represented by the segment B1.

At the time T1, the activity or the multiplied value increases by a value represented by an arrow A12. The increase represented by the arrow A12 is equal to or less than the positive predetermined threshold value (NO at step S3, S4, S5, and S6). It is determined that the scene change does not occur around the time T1 (step S7, NO at step S12).

From the time T1 to the time T2, the activity or the multiplied value takes a value represented by a segment A2. The target code amount is set to be a value represented by a segment B2 previously set in accordance with the value represented by the segment A2 as it is (step S13). The output code amount takes a value represented by a segment C2 in accordance with the value represented by the segment B2.

At the time T2, the activity or the multiplied value increases by a value represented by an arrow A23. The increase represented by the arrow A23 is larger than the positive predetermined threshold value (YES at step S3 and S4). It is determined that the first scene change occurs around the time T2 (step S8, YES at step S12, “FIRST” at step S14).

From the time T2 to the time T3, the activity or the multiplied value takes a value represented by a segment A3. At the time T2, the target code amount is set to be a value obtained by forcibly executing reduction correction by the correction code amount represented by an arrow B23 on a value represented by a segment B4 previously set in accordance with the value represented by the segment A3 (step S15). The target code amount is set so as to gradually increase to the value represented by the segment B4 from the time T2 until an elapse of the time TB3, as shown in a curve B3 (step S16). The target code amount is set to be a value represented by the segment B4 after the elapse of the time TB3.

The output code amount, at the time T2, takes a value obtained by adding a value represented by an arrow C23 to a value represented by a segment C4 instead of taking the value represented by the segment C4 in accordance with the value represented by the segment B4. The output code amount gradually decreases to the value represented by the segment C4 from the time T2 until an elapse of the time TC3, as shown in a curve C3. The output code amount takes the value represented by the segment C4 after the elapse of the time TC3.

Although the activity or the multiplied value increases by the value represented by the arrow A23, the output code amount only increases to the value represented by the arrow C23 from the value represented by the segment C4. That is to say, when the transcoder 1 detects a fact that the moving image changes to the fine image from the flat image, deterioration of image quality at the time of the scene change can be prevented while the increase in the output code amount is suppressed.

At the time T3, the activity or the multiplied value decreases by a value represented by an arrow A34. The decrease represented by the arrow A34 is equal to or less than the positive predetermined threshold value (NO at step S3, S4, S5, and S6). It is determined that the scene change does not occur at the time T3 (step S7, NO at step S12).

From the time T3 to the time T4, the activity or the multiplied value takes a value represented by a segment A4. The target code amount is set to be a value represented by a segment B5 previously set in accordance with the value represented by the segment A4 as it is (step S13). The output code amount takes a value represented by a segment C5 in accordance with the value represented by the segment B5.

At the time T4, the activity or the multiplied value decreases by a value represented by an arrow A45. The decrease represented by the arrow A45 is larger than the positive predetermined threshold value (NO at step S3 and S4, YES at step S5 and S6). It is determined that the second scene change occurs at the time T4 (step S9, YES at step S12, “SECOND” at step S14).

From the time T4, the activity or the multiplied value takes a value represented by a segment A5. The target code amount is set to be a value obtained by forcibly executing increase correction by the correction code amount represented by an arrow B67 on a value represented by a segment B7 previously set in accordance with the value represented by the segment A5 at the time T4 (step S17). The target code amount is set so as to gradually decrease to the value represented by the segment B7 from the time T4 until an elapse of the time TB6, as shown in a curve B6 (step S18). The target code amount is set to be the value represented by the segment B7 after the elapse of the time TB6.

The output code amount, at the time T4, takes a value obtained by subtracting a value represented by an arrow C67 from a value represented by a segment C7 instead of taking the value represented by the segment C7 in accordance with the value represented by the segment B7. The output code amount gradually increases to the value represented by the segment C7 from the time T4 until an elapse of the time TC6, as shown in a curve C6. The output code amount takes the value represented by the segment C7 after elapse of the time TC6.

Although the activity or the multiplied value decreases by the value represented by the arrow A45, the output code amount only decreases to the value represented by the arrow C67 from the value represented by the segment C7. That is to say, when the transcoder 1 detects a fact that the moving image changes to the flat image from the fine image, deterioration of image quality at the time of the scene change can be prevented while decrease in the output code amount is suppressed.

{Second Specific Example of Process Flow by the Transcoder 1}

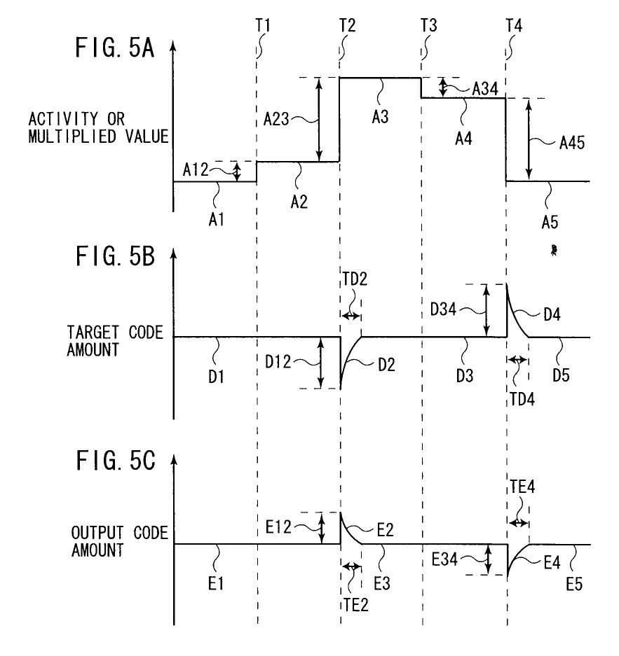

FIGS. 5A to 5C are time charts showing a second specific example of process flow by the transcoder 1. Also, FIG. 5A is a time chart showing a time change of the activity or the multiplied value. FIG. 5B is a time chart showing a time change of the target code amount. FIG. 5C is a time chart showing a time change of the output code amount. Four dashed lines passing through FIGS. 5A to 5C in the vertical direction represent the times T1, T2, T3, and T4 in the order from the left side to the right side.

The activity or the multiplied value varies momentarily. However, in FIG. 5A, the activity or the multiplied value varies only at the times T1, T2, T3, and T4 for convenience of explanation.

In the second specific example, the target code amount preciously set at step S13, S15, and S17 is the target code amount which is set for all streams not depending on the fineness degree of the input image included in the predetermined unit such as a GOP unit and based on the average fineness degree of the input image included in all streams and which is not corrected.

By the time T1, the activity or the multiplied value takes a value represented by a segment A1. The target code amount takes a value set for all streams, which is represented by a segment D1. The output code amount takes a value represented by a segment E1 in accordance with the value represented by the segment D1.

It is determined that the scene change does not occur at the time T1 in likewise FIG. 4A (step S7, NO at step S12).

From the time T1 to the time T2, the activity or the multiplied value takes a value represented by a segment A2. The target code amount keeps taking the value set for all streams, which is represented by the segment D1 (step S13). The output code amount keeps taking the value represented by the segment E1 in accordance to the value represented by the segment D1.

It is determined that the first scene change occurs at the time T2 in likewise FIG. 4A (step S8, YES at step S12, “FIRST” at step S14).

From the time T2 to the time T3, the activity or the multiplied value takes a value represented by a segment A3. At the time T2, the target code amount takes a value obtained by forcibly executing reduction correction by the correction code amount represented by an arrow D12 on a value set for all streams, which is represented by a segment D3 (step S15). The target code amount gradually increases to a value represented by the segment D3 from the time T2 until an elapse of the time TD2, as shown in a curve D2 (step S16). The target code amount takes the value represented by the segment D3 after the elapse of the time TD2.

At the time T2, the output code amount takes a value obtained by adding a value represented by an arrow E12 to a value represented by a segment E3 instead of taking the value represented by the segment E3 in accordance with the value represented by the segment D3. The output code amount gradually decreases to the value represented by the segment E3 from the time T2 until an elapse of the time TE2, as shown in a curve E2. The output code amount takes the value represented by the segment E3 after the elapse of the time TE2.

Although the activity or the multiplied value increases by a value represented by an arrow A23, the output code amount only increases to a value represented by an arrow E12 from the value represented by the segment E3. That is to say, when the transcoder 1 detected a fact that the moving image changes to the fine image from the flat image, deterioration of image quality at the time of the scene change can be prevented while the increase in the output code amount is suppressed.

It is determined that the scene change does not occur at the time T3 in likewise FIG. 4A (step S7, NO at step S12).

From the time T3 to the time T4, the activity or the multiplied value takes a value represented by a segment A4. The target code amount keeps taking the value set for all streams, which is represented by the segment D3 (step S13). The output code amount keeps taking the value represented by the segment E3 in accordance to the value represented by the segment D3.

It is determined that the second scene change occurs at the time T4 in likewise FIG. 4A (step S9, YES at step S12, “SECOND” at step S14).

From the time T4, the activity or the multiplied value takes a value represented by a segment A5. The target code amount takes a value obtained by forcibly executing increase correction by the correction code amount represented by an arrow D34 on a value set for all streams, which is represented by a segment D5 at the time T4 (step S17). The target code amount gradually decreases to the value represented by the segment D5 from the time T4 until an elapse of the time TD4, as shown in a curve D4 (step S18). The target code amount takes the value represented by the segment D5 after the elapse of the time TD4.

The output code amount takes a value obtained by subtracting a value represented by an arrow E34 from a value represented by a segment E5 instead of taking the value represented by the segment E5 in accordance with the value represented by the segment D5. The output code amount gradually increases to the value represented by the segment E5 from the time T4 until an elapse of the time TE4, as shown in a curve E4. The output code amount takes the value represented by the segment E5 after the elapse of the time TE4.

Although the activity or the multiplied value decreases by a value represented by an arrow A45, the output code amount only decreases to the value represented by the arrow E34 from the value represented by the segment E5. That is to say, when the transcoder 1 detects a fact that the moving image changes to the flat image from the fine image, deterioration of image quality at the time of the scene change can be prevented while the decrease in the output code amount is suppressed.

{Selection Method of Previous Input Image and Subsequent Input Image}

The moving image comprises a GOP (Group of Pictures). The GOP comprises I picture, P picture, and B picture. Quantization step average values in each picture normally increase in the order of I picture, P picture, and B picture. Distributions of the code amount to each picture normally decrease in the order of I picture, P picture, and B picture.

Desirably, the scene change detection part 124 can accurately compare the fineness degree of the subsequent input image with that of the previous input image. Therefore, the scene change detection part 124 selects same kinds of picture as the previous input image and the subsequent input image. That is to say, when the scene change detection part 124 selects I picture, P picture, and B picture as the previous input image, the scene change detection part 124 selects I picture, P picture, and B picture as the subsequent input image, respectively.

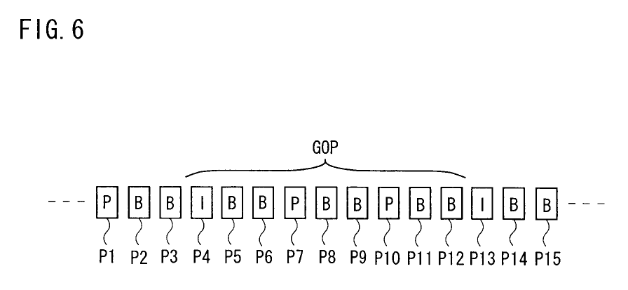

FIG. 6 is a drawing showing a picture used in detection of the scene change. A picture P1 to a picture P15 are parts of a picture constituting a moving image. A picture P4 to a picture P12 are a picture constituting a GOP unit. Left side pictures are preceding pictures and right side pictures are subsequent pictures.

It is assumed that the scene change detection part 124 selects only I picture as the previous input image and the subsequent input image and does not select P picture and B picture. The scene change detection part 124 determines whether the scene change occurs between a picture P4 and a picture P13. However, the scene change detection part 124 detects the scene change late when a true scene change occurs between the picture P4 and the picture P13.

It is assumed that the scene change detection part 124 selects only I picture and P picture as the previous input image and the subsequent input image and does not select B picture. The scene change detection part 124 determines whether a scene change occurs between a picture P7 and a picture P10. However, the scene change detection part 124 detects the scene change slightly late when the true scene change occurs between the picture P7 and the picture P10.

Then, when the scene change detection part 124 selects I picture, P picture, and B picture as the previous input image, the scene change detection part 124 selects I picture, P picture, and B picture as the subsequent input image, respectively. The scene change detection part 124 can accurately compare the fineness degree of the subsequent input image with that of the previous input image and can detect the scene change in real time.

A predetermined threshold value of a subtracted value of the activity at step S3 and S5 and a predetermined threshold value of a subtracted value of the multiplied value at step S4 and S6 may be different or identical for each of I picture, P picture, and B picture. When they are different, the scene change detection part 124 can accurately compare the fineness degree of the subsequent input image with that of the previous input image. When they are identical, the scene change detection part 124 can easily compare the fineness degree of the subsequent input image with that of the previous input image.

Pictures compared at steps S3 and S5 may be selected from same or different kinds of pictures among I picture, P picture, and B picture. When the pictures are selected from same kinds of pictures, the scene change detection part 124 can accurately compare the fineness degree of the subsequent input image with that of the previous input image. When the pictures are selected from different kinds of pictures, the scene change detection part 124 can easily compare the fineness degree of the subsequent input image with that of the previous input image.

{Method of Restarting Detection of Scene Change After Detection of Scene Change}

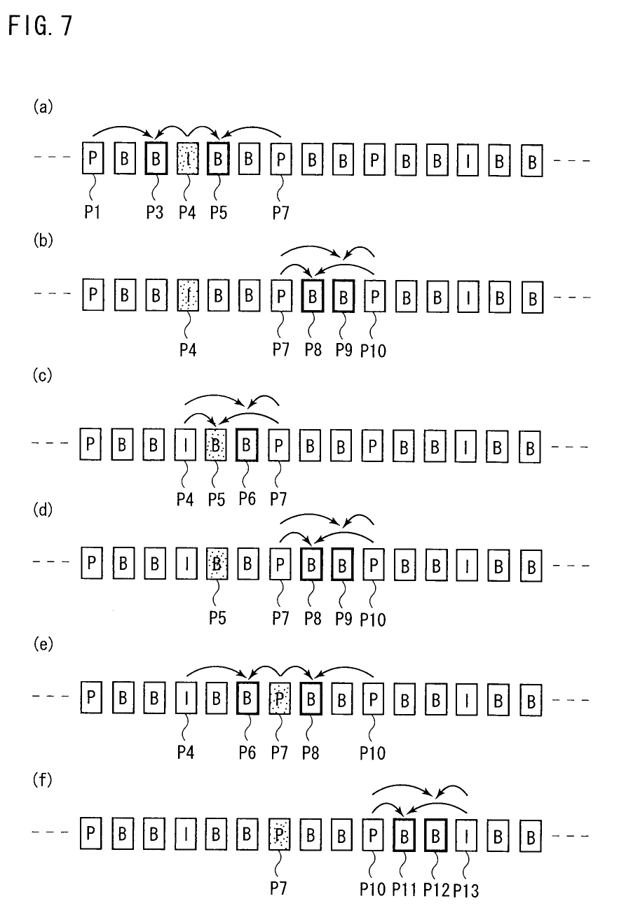

It is assumed that the scene change detection part 124 restarts detection of a scene change immediately after detection of the scene change. In this case, the scene change detection part 124 is more likely to erroneously detect the scene change as shown in FIGS. 7A, 7C, and 7E.

Then, the scene change detection part 124 does not restart detection of the scene change immediately after detection of the scene change as shown in FIGS. 7B, 7D and 7F. Therefore, the scene change detection part 124 is less likely to erroneously detect the scene change.

FIGS. 7A and 7B are drawings showing a method of restarting detection of the scene change after detection of the scene change in the case where the scene change was detected when the scene change detection part 124 selected an I picture P4 as the subsequent input image. The I picture P4 is represented by sanded area. In FIG. 7A, the scene change detection part 124 selects a B picture P5 which is subsequent by one picture to the I picture P4 as the subsequent input image. The scene change detection part 124 selects a B picture P3 nearest from the B picture P5 as the previous input image.

The B picture P5 is a predicted image which refers to the I picture P4 and a P picture P7. The B picture P3 is a predicted image which refers to a P picture P1 and the I picture P4. Here, the P picture P1 to which the B picture P3 refers is an input image before the scene change. Therefore, the scene change detection part 124 is more likely to erroneously detect the scene change although the scene change was just detected.

In FIG. 7B, the scene change detection part 124 selects a B picture P9 which is subsequent by five pictures to the I picture P4 as the subsequent input image. The scene change detection part 124 selects a B picture P8 nearest from the B picture P9 as the previous input image.

The B picture P9 is a predicted image which refers to the P picture P7 and a P picture P10. The B picture P8 is a predicted image which refers to the P picture P7 and the P picture P10. Here, the P picture P7 to which the B picture P8 and the B picture P9 refer is an input image after the scene change. The scene change detection part 124 is less likely to erroneously detect the scene change by selecting the previous input image such that the previous input image is to be an input image after detection of the scene change. Then, the scene change detection part 124 may restart detection of the scene change from a state shown in FIG. 7B.

FIGS. 7C and 7D are drawings showing a method of restarting detection of the scene change after the detection of the scene change in the case where the scene change was detected when the scene change detection part 124 selected the B picture P5 as the subsequent input image. The B picture P5 is represented by sanded area.

In FIG. 7C, the scene change detection part 124 selects a B picture P6 which is subsequent by one picture to the B picture P5 as the subsequent input image. The scene change detection part 124 selects the B picture P5 nearest from the B picture P6 as the previous input image.

The B picture P6 is a predicted image which refers to the I picture P4 and the P picture P7. The B picture P5 is a predicted image which refers to the I picture P4 and the P picture P7. Here, the I picture P4 to which the B picture P5 and the B picture P6 refer is an input image before the scene change. Therefore, the scene change detection part 124 is more likely to erroneously detect the scene change although the scene change was just detected.

In FIG. 7D, the scene change detection part 124 selects the B picture P9 which is subsequent by four pictures to the B picture P5 as the subsequent input image. The scene change detection part 124 selects the B picture P8 nearest from the B picture P9 as the previous input image.

The B picture P9 is a predicted image which refers to the P picture P7 and the P picture P10. The B picture P8 is a predicted image which refers to the P picture P7 and the P picture P10. Here, the P picture P7 to which the B picture P8 and the B picture P9 refer is an input image after the scene change. The scene change detection part 124 is less likely to erroneously detect the scene change by selecting the previous input image such that the previous input image is to be an input image after detection of the scene change. Then, the scene change detection part 124 may restart detection of the scene change from a state shown in FIG. 7D.

FIGS. 7E and 7F are drawings showing a method of restarting detection of the scene change after the detection of the scene change in the case where the scene change was detected when the scene change detection part 124 selected the P picture P7 as the subsequent input image. The P picture P7 is represented by sanded area.

In FIG. 7E, the scene change detection part 124 selects the B picture P8 which is subsequent by one picture to the P picture P7 as the subsequent input image. The scene change detection part 124 selects the B picture P6 nearest from the B picture P8 as the previous input image.

The B picture P8 is a predicted image which refers to the P picture P7 and the P picture P10. The B picture P6 is a predicted image which refers to the P picture P4 and the P picture P7. Here, the I picture P4 to which the B picture P6 refers is an input image before the scene change. Therefore, the scene change detection part 124 is more likely to erroneously detect the scene change although the scene change was just detected.

In FIG. 7F, the scene change detection part 124 selects a B picture P12 which is subsequent by five pictures to the P picture P7 as the subsequent input image. The scene change detection part 124 selects a B picture P11 nearest from the B picture P12 as the previous input image.

The B picture P12 is a predicted image which refers to the P picture P10 and a I picture P13. The B picture P11 is a predicted image which refers to the P picture P10 and the I picture P13. Here, the P picture P10 to which the B picture P11 and the B picture P12 refer is an input image after the scene change. The scene change detection part 124 is less likely to erroneously detect the scene change by selecting the previous input image such that the previous input image is to be an input image after detection of the scene change. Then, the scene change detection part 124 may restart detection of the scene change from a state shown in FIG. 7F.

In an example of FIG. 7, a GOP in which detection of the scene change is restarted is same as a GOP in which the scene change is detected. In another example, the GOP in which detection of the scene change is restarted may be a GOP immediately after the GOP in which the scene change is detected. It is understood that the scene change detection part 124 is less likely to erroneously detect the scene change in consideration that the moving image comprises a plurality of GOPs such that a predicted error does not broadly affect the direction of the time axis.

While the invention has been shown and described in detail, the foregoing description is in all aspects illustrative and not restrictive. It is therefore understood that numerous modifications and variations can be devised without departing from the scope of the invention.

What is claimed is:

1. A transcoder which decodes an input image into a decoded image and encodes said decoded image into an output image, comprising:
a characteristic amount detection part which detects a characteristic amount of said input image;
a scene change detection part which determines that when a differential value between a characteristic amount of a previous input image and a characteristic amount of a subsequent input image is larger than a predetermined characteristic amount differential value, a scene change occurs between said previous input image and said subsequent input image;
a target code amount setting part which sets a target code amount of said output image based on said characteristic amount of said input image; and
a target code amount correction part which corrects a target code amount of a subsequent output image by a correction code amount such that a variation from an output code amount of a previous output image corresponding to said previous input image to an output code amount of said subsequent output image corresponding to said subsequent input image when said scene change occurs.

2. The transcoder according to claim 1, wherein
said target code amount correction part includes a target code amount correction end part which ends correction of said target code amount of said output image after a first predetermined period of time since correction of said target code amount of said output image is started.

3. The transcoder according to claim 1, wherein
said target code amount of said output image includes a first target code amount set based on a characteristic amount in a predetermined unit of said input image.

4. The transcoder according to claim 1, wherein
said target code amount of said output image includes a second target code amount set based on an average characteristic amount in the entire of said input image.

5. The transcoder according to claim 1, wherein
said correction code amount includes a code amount set based on a differential value between said characteristic amount of said previous input image and said characteristic amount of said subsequent input image.

6. The transcoder according to claim 1, wherein
said characteristic amount includes a value obtained by dividing a value obtained by summing difference absolute values between pixel values of adjacent pixels of said input image for all adjacent pixels of said input image by a total block number of said input image.

7. The transcoder according to claim 1, wherein
said characteristic amount includes a value obtained by multiplying a value obtained by averaging the quantization step value in each block of said input image for a total block number of said input image by a code amount of said input image.

8. The transcoder according to claim 1, wherein
said characteristic amount includes a value obtained by dividing a value obtained by summing code amounts of moving vectors in each block of said input image for all blocks of said input image by a total block number of said input image.

9. The transcoder according to claim 1, wherein
said characteristic amount includes a value obtained by dividing a value obtained by summing lengths of moving vectors in each block of said input image for all blocks of said input image by a total block number of said input image.

10. The transcoder according to claim 1, wherein
said subsequent input image includes one kind image of a reference image, a forward predicted image, and a bidirectional predicted image, and
said previous input image includes said one kind image of a reference image, a forward predicted image, and a bidirectional predicted image which is a nearest image of said subsequent input image.

11. The transcoder according to claim 10, wherein
said characteristic amount includes an individual characteristic amount which is detected for each of a reference image, a forward predicted image, and a bidirectional predicted image, and
said predetermined characteristic amount differential value includes an individual differential value which is set for each of said reference image, said forward predicted image, and said bidirectional predicted image.

12. The transcoder according to claim 1, wherein
said scene change detection part includes a scene change detection restart part which restarts detection of the scene change after a second predetermined period of time since it is determined that said scene change occurs, and
said second predetermined period is a period from occurrence of said scene change until a reference image to which said previous input image refers is arranged later in a direction of time axis rather than a scene change generation image in which said scene change occurs.
